(19) United States
(12) Patent Application Publication
(10) Pub. No.: US 2009/0206107 A1
(43) Pub. Date: Aug. 20, 2009

(54) HYDRATION DEVICE

(76) Inventors: Gal RAZ, Zoran (IL); Guy KOTLIZKY, Kfar-Shemaryahu (IL)

Correspondence Address: MARTIN D. MOYNIHAN d/b/a PRTSI, INC., P.O. BOX 16446, ARLINGTON, VA, 22215, US

(21) Appl. No.: 12/432,776

(22) Filed: Apr. 30, 2009

Related U.S. Application Data
(63) Continuation-in-part of application No. PCT/IL2007/001323, filed on Oct. 30, 2007.
(60) Provisional application No. 60/855,138, filed on Oct. 30, 2006.

(51) Int. Cl. B67D 5/64; A47G 19/14

(52) U.S. Cl. 222/175; 222/465.1

(57) ABSTRACT

A device comprising a flexible container for facilitating suction of a liquid contained therein is provided. The device includes a bite valve for controlling fluid ingestion.

### RELATED APPLICATIONS

This application is a Continuation-In-Part (CIP) Patent Application of PCT Patent Application No. PCT/IL2007/001323 having International Filing Date of Oct. 30, 2007, which claims benefit of U.S. Provisional Patent Application No. 60/855,138, filed on Oct. 30, 2006. The contents of the above Applications are all incorporated herein by reference.

### FIELD AND BACKGROUND OF THE INVENTION

The present invention relates to a hydration device and, more particularly, to a liquid container which is designed for facilitating intake of liquids such as sports drinks during activity, such as sports activity.

Carbohydrate supplements are used to provide energy and are useful before, during and after physical activity.

Carbohydrate supplements are sold in the form of bars (energy bars), gels (energy gels) or liquids (sports drinks). Such supplements are designed for increasing or extending muscle glycogen stores and providing additional calories and energy for strenuous activities of more than 2 hours.

Energy bars (e.g. Powerbar™) provide a source of energy, primarily complex carbohydrates, a source of protein (often soy), plus a selection of vitamins and minerals as well as flavoring in a solid form (bar) which is similar in consistency to baked goods (e.g. cookies).

Energy gels (e.g. Hammer™ gel) provide a combination of simple and complex carbohydrates (maltodextrin, rice syrup, or polysaccharides) in a palm sized packet of plastic or foil with a tear off end which allows the contents to be squeezed out of the packet. Energy gels provide between 70 and 100 Calories (17-25 grams of carbohydrate) per packet. Being semi-liquid, gels empty more quickly from the stomach providing a more rapid energy boost than solid bars.

Manufacturers recommend that 60 grams of carbohydrate be ingested per hour to supplement exercising muscle glycogen supplies which translates to a bar or gel packet every 30 to 45 minutes of physical activity.

Both bars and gels are limited in that they necessitate co-consumption of water both to facilitate ingestion of the bar or gel and to provide the hydration required during exercising.

Sports drinks (e.g. Isostar™) are typically marketed as powders for reconstitution in water or as bottled drinks. Sports drinks provide the necessary fluids an active person needs and in addition also help maintain stamina in events or exercise sessions lasting longer than 60 minutes. In addition, sports drinks actually enhance fluid absorption in the small intestine due to their glucose and sodium content.

Although sports drinks are advantageous in that they provide both the hydration and carbohydrates needed by an athlete, such drinks are limited by the fact that they are more difficult to carry and consume (during activity) as compared to gel packets.

While reducing the present invention to practice, the present inventors have devised a container for sports drinks which can be easily carried by an athlete such as a cyclist while enabling fast and easy suctioning of the sports drink during activity.

### SUMMARY OF THE INVENTION

According to one aspect of the present invention there is provided a device comprising a flexible container having a port for facilitating suction of a liquid contained in the flexible container.

According to further features in preferred embodiments of the invention described below, the device further comprises a valve positioned in or on the port.

According to still further features in the described preferred embodiments the valve is a bite valve.

According to still further features in the described preferred embodiments the valve is a pull valve.

According to still further features in the described preferred embodiments the container is made from a polymer and/or foil.

According to still further features in the described preferred embodiments the container is designed for storage in a pocket of a clothing item.

According to still further features in the described preferred embodiments the clothing item is a cycling shirt.

According to still further features in the described preferred embodiments the device further includes a handle for facilitating transport and/or use of the container.

According to still further features in the described preferred embodiments the handle is designed for facilitating removal of the container from pocket of a clothing item.

According to still further features in the described preferred embodiments the handle forms a part of the inner element.

According to still further features in the described preferred embodiments at least a portion of the inner element also serves as a conduit for the liquid.

According to still further features in the described preferred embodiments the inner element is configured so as to mechanically distract opposing walls of the container.

According to still further features in the described preferred embodiments the inner element is configured so as to prevent capillary adhesion between opposing walls of the container.

According to still further features in the described preferred embodiments the inner element includes a portion shaped in a zigzag pattern.

According to still further features in the described preferred embodiments the inner element is constructed such that the device is symmetrical around a longitudinal axis thereof.

According to still further features in the described preferred embodiments the inner element enables liquid consumption while the flexible container is inverted with the port side down.

The present invention successfully addresses the shortcomings of the presently known configurations by providing a device for consuming liquids such as sports drinks in a fast and easy manner.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-B illustrates one embodiment of a hydration device constructed in accordance with the teachings of the present invention showing the construction of the flexible container. FIG. 1A—an exploded view of one embodiment of the present device; FIG. 1B—an assembled view of a second embodiment including an inner element for preventing complete collapse of the container under suction.

FIGS. 2A-C illustrate several configurations of an inner element designed for reducing/preventing collapse of the liquid container of the hydration device of the present invention when a liquid is suctioned out therefrom.

### DESCRIPTION OF THE PREFERRED EMBODIMENTS

The present invention is of a device which can be used to consume liquid beverages, such a sports drink during activity, while being easier to carry and deploy than a sports bottle.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Although carbohydrate supplements can be consumed as bars gels or drinks, for the reasons stated hereinabove, the present inventors believe that liquid supplements possess several key advantages over bars or gels.

Presently marketed sports drinks formulations are efficacious in providing optimal proportions of carbohydrates and salts and are only limited by the packaging used for consumption (sports bottles).

To facilitate ingestion of such drinks, especially by cyclists, the present inventors have devised a novel sports drink device which enables a user to easily carry the device in or on clothing items while also enabling rapid and easy deployment and ingestion (e.g. through squeezing or suctioning) of the sports drink while exercising (e.g. cycling).

Thus, according to one aspect of the present invention, there is provided a device for providing hydration and/or energy supplement to a subject.

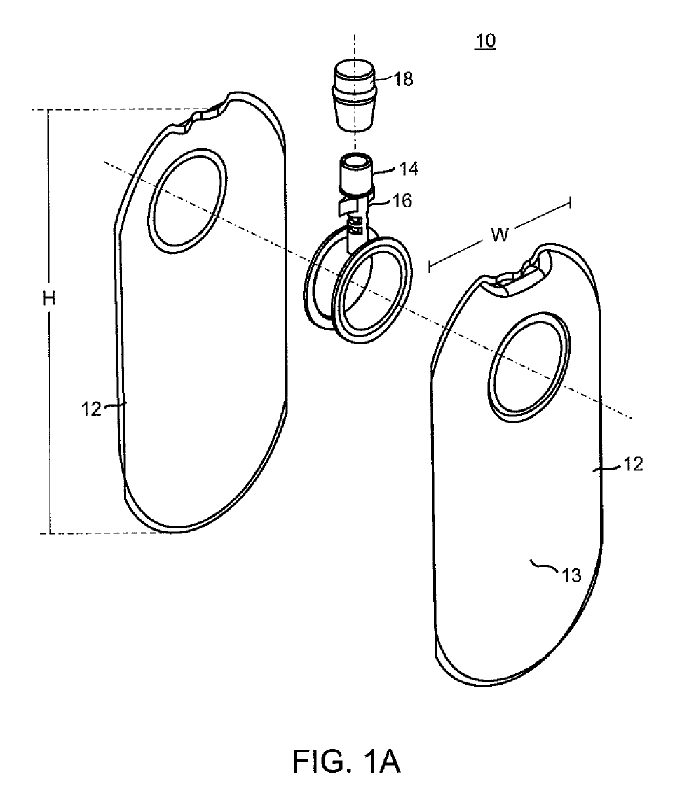

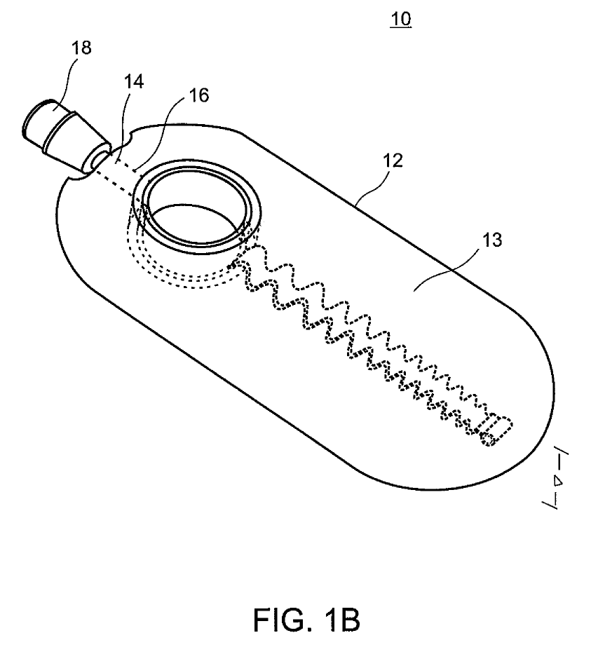

FIG. 1a illustrates one embodiment of the present device which is referred to herein as device 10.

Device 10 includes a flexible container 12 which is designed for containing a liquid such a sports drink, water and the like.

As used herein, the phrase “flexible container” refers to an enclosed container (in the form of a pouch or sac) which is fabricated from a flexible material which is deformable and thus can be squeezed or squished to eject a fluid contained therein.

Container 12 is preferably fabricated from a soft polymer such as polyurethane, polypropylene, polyethylene, silicone, foil as well as laminated materials such as HDPE/aluminum/HDPE or HDPE/carton/HDPE using well known welding techniques and/or gluing. As is illustrated in FIG. 1a, container 12 can be fabricated by welding or gluing two side panels around an inner element (further described hereinbelow). Container 12 is designed for containing 100-400 ml, preferably 150-350 ml, more preferably 200-300 ml. An amount in the range of 200-300 ml is preferred since it provides a good balance between rapid consumption (can be consumed via one fast gulp) and the required fluid hydration and carbohydrate supplementation.

Container 12 can be shaped as a rectangle, square, triangle or any amorphous shape, the container depicted in FIG. 1b is shaped as an oval. Preferred shapes are those which facilitate storage of device 10 in pockets of a clothing item (e.g. shirt, pants, shorts) or pouches of a bag (e.g. backpack). Typical dimensions for container 12 are 10-25 cm in height (H, FIG. 1a), 5-15 cm in width (W, FIG. 1a) with depth (D, FIG. 1b) varying along the length of the device and not exceeding 8 cm at any point (when filled with liquids). Surface 13 of container 12 can be smooth or textured. It will be appreciated that a textured surface can facilitate handling of device 10 while a subject is engaged in physical activity.

Device 10 further includes a port 14 for facilitating consumption of liquid contained in container 12. Port 14 is fabricated from a material which is soft enough to bite and yet hard enough to retain a shape necessary for providing fluid flow through a fluid passageway 16 thereof. The diameter of fluid passageway 16 of Port 14 can be in the range of 5-20 mm, preferred 7-10 mm.

Port 14 can be fabricated from silicone, polyurethane, polypropylene, polyethylene and the like.

Although less preferred, container 12 can also be fabricated without a port, in which case, a user can simply bite off a corner of container 12 to facilitate drinking.

Although device 10 is designed having dimensions suitable for carrying quantities of fluid which are ingestible via a single gulp, it is possible that users will prefer consuming the contents of device 10 over several drinking sessions. Thus, it would be advantageous to include a valve 18 in port 14 such that fluid is not lost from container 12 when device 10 is not in use (e.g. tucked in a back pocket of a cyclist).

Several types of valve 18 can be utilized by the present invention. Preferred are bite valves (examples of which are provided in U.S. Pat. Nos. 2,219,064; 5,971,357 and 5,601,207) which include a deformable slit or slits and pull valves such as those utilized in sports bottles.

Port 14 can be glued or welded at any point around a circumference of container 12. Preferred regions are those which are most accessible by a subject grasping device 10. Port 14 is preferably mounted over a spout portion of an element 20 which is further described below.

As is mentioned hereinabove, one preferred mode of consumption from device 10 is hands free suctioning of fluids. Since container 12 is preferably fabricated from flexible material, the negative pressure which results from suctioning of liquids can result in a collapse and adhesion (capillary) of opposing walls of container 12. Such a situation can lead to reduced suctioning efficiency and increased difficulties in liquid consumption.

While experimenting with several container designs, the present inventors have realized that an inner element which is designed for maintaining opposing walls of container 12 apart can be used to prevent the above described phenomenon.

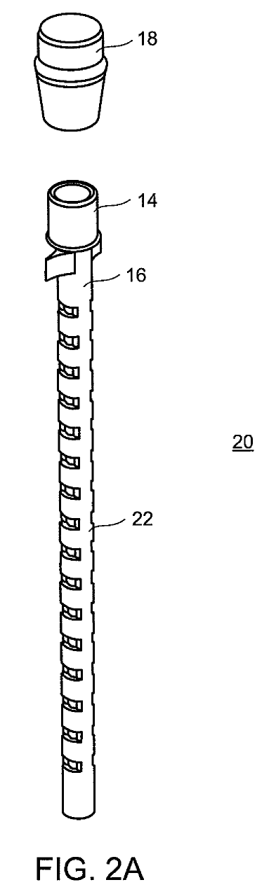

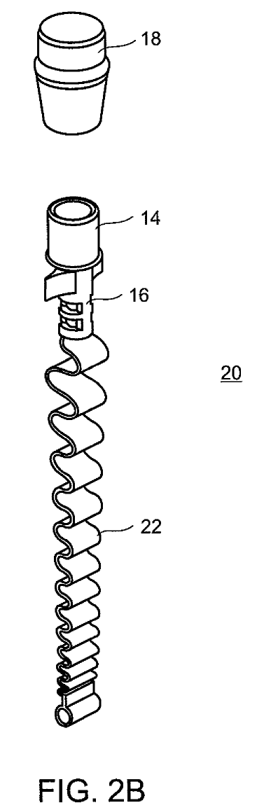

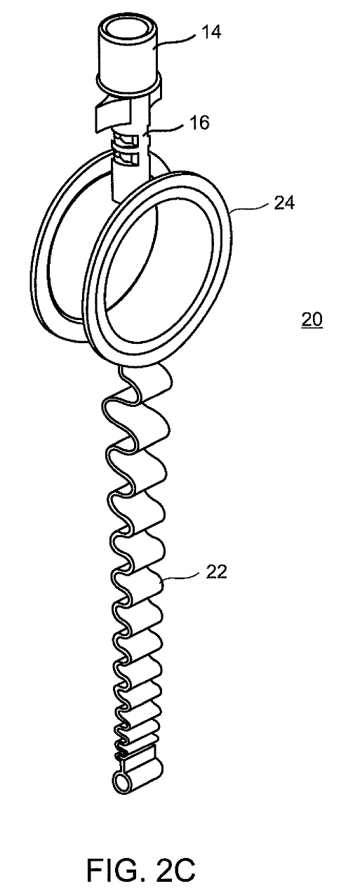

FIGS. 2a-c illustrate several exemplary embodiments of an inner element which is referred to herein as element 20. FIG. 1b illustrates positioning of inner element 20 within container 12 of device 10.

Inner element 20 is preferably fabricated from a polymer such as polyurethane and the like and is provided with elasticity such that it does no negatively impact the characteristics of container 12.

FIG. 2a illustrates one specific embodiment of element 20. In this embodiment, element 20 includes a portion 22 which is elastic (preferably along an axis defining a width of container 12) and is shaped such that it keeps opposing walls of container 12 apart while at the same time allows transport of fluids there across. The latter functionality is achieved in this embodiment by providing hole-shaped liquid conduits along the length of portion 22.

Element 20 can optionally incorporate port 14 which connects an inner volume of container 12 to valve 18. Port 14 portion of element 20 can extend to the bottom of container 12 in which case its bottom portion also serves to maintain opposing walls apart, or it can extend just below a top portion of container 12 as is shown in FIG. 1.

FIG. 2b illustrates an element 20 which has a zig-zag configuration of portion 22, in this configuration the conduits are formed by the troughs in the zig-zagging pattern.

As is mentioned hereinabove, container 12 is designed for storage within pockets of a clothing item such as a cycling jersey. Thus, device 10 also includes a handle 24 which are designed specifically for facilitating removal of device 10 from a pocket.

FIG. 2c illustrates an element 20 which integrates a handle 24 as well as portion 22 and port 14 described above (valve 18 not shown). Handle 24 is preferably fabricated form the same material as element 20 using an injection molding process. It will be appreciated that although a round handle is depicted, other shapes and dimensions are also envisaged. Handle 24 is preferably formed in element 20 such that it occupies an above midline position in device 10 (e.g. top 30%).

The configuration shown in FIG. 2c can be fabricated as a single molded piece from polyethylene, polyurethane or polypropylene.

Device 10 can be fabricated using any one of several container-fabrication processes known in the art. Preferably, device 10 is fabricated by constructing container 12 (e.g. welding) around element 20 such that walls of container 12 are attached around port 14, and handle 24 portion of element 20.

Container 12 of device 10 can be filled during manufacturing with water or preferably a sports drink. Filling can be performed manually or automatically through port 14 following which a valve 18 (further described below) can be fitted over port 14 and sealed via heat shrunk plastic.

Any sports drink formulation would be suitable for use with the present device. Typical sports drink formulations include high fructose corn syrup, sucrose, glucose and/or corn starch as a source of carbohydrates, as well as calcium, magnesium, chloride, sodium, potassium and flavorings. Sports drink formulation are well known to the ordinary skilled artisan and thus no further description of specific amounts and ingredients is provided herein. For further description of sports drink formulations, please see, “The sports drink as a functional food: Formulations for successful performance” Maughan, Proceedings of the Nutrition Society, Volume 57, Number 1, February 1998, pp. 15-23(9).

Thus, the present invention provides a device for facilitating consumption of a sports drink or water during physical activity such as cycling, hiking, climbing, workouts and the like. To consume the contents of device 10, a user simply holds container 12 and while placing port 14 in mouth (and biting on valve 18), the user squeezes or squishes container 12 to empty its contents into mouth or alternatively and preferably simply sucks on valve 18. Following complete consumption, device 10 can be disposed of in a sanitary manner.

It will be appreciated that since device 10 can be utilized by cyclists and hikers, and since container 12 has relatively large and flat outer surface, printed trail maps can be provided on container 12 to enhance riding experience. A configuration used by cyclists is preferably constructed having symmetry around a longitudinal axis thereof. Such symmetry ensures that a cyclist can grab the device and drink therefrom regardless of the front/back orientation of the device in a cycling jersey pocket. In addition, the present device is preferably constructed such that when positioned within a cycling jersey back pocket, handle 24 protrudes out of the pocket and is thus easily located and grabbed by the cyclist.

Although the present device can easily be consumed by simply squeezing flexible container 12 or by sucking on valve 18, addition of a pressurizing element to the flexible container can further facilitate consumption. Such a pressurizing element can be an elastic band which is stretched around the outside of flexible container 12 thereby applying pressure thereupon. The pressure applied by such a pressurizing element would thus enable consumption by simply opening valve 18 (e.g. by biting it).

It is expected that during the life of this patent many relevant sports drink formulations will be developed and the scope of the term sports drink is intended to include all such new technologies a priori.

As used herein the term “about” refers to ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A device comprising a flexible container designed for containing about 100-400 ml of a liquid and a port for facilitating ingestion of said liquid.

2. The device of claim 1, further comprising a valve positioned in or on said port.

3. The device of claim 2, wherein said valve is a bite valve.

4. The device of claim 2, wherein said valve is a pull valve.

5. The device of claim 1, wherein said container is made from a polymer and/or foil.

6. The device of claim 1, wherein said container is sized and configured for storage in a pocket of a clothing item.

7. The device of claim 6, wherein said clothing item is a cycling shirt.

8. The device of claim 1, wherein the device further includes a handle for facilitating transport and/or use of said container.

9. The device of claim 8, wherein said handle is designed for facilitating removal of said container from pocket of a clothing item.

10. The device of claim 1, further comprising a sports drink in said container.
